(19) United States
(12) Patent Application Publication
(10) Pub. No.: US 2013/0124995 A1
(43) Pub. Date: May 16, 2013

(54) DOCUMENT AUTHORING

(71) Applicant: Yohko Kelley, Woodinville, WA (US)

(72) Inventor: Yohko Kelley, Woodinville, WA (US)

(21) Appl. No.: 11/769,302

(22) Filed: Jun. 27, 2007

(51) Int. Cl. G06F 15/00

(52) U.S. Cl. 715/718; 715/799

(57) ABSTRACT

Embodiments of methods, devices and/or systems for authoring a document are described.

### FIELD

This disclosure is related to the authoring of documents. For example, a document may be authored in an authoring environment by employing a display and graphical user interface (GUI).

### BACKGROUND

Documents including on-screen or print documents may be authored in an authoring environment. Typically, a display and graphical user interface are employed in an authoring environment such that a document in process is displayed on-screen during an authoring process. As part of the authoring process, a preview of a final version of the document is typically displayed on-screen on a display. The preview of the document will typically be displayed in order for an author to visualize a final version of the document.

### BRIEF DESCRIPTION OF THE DRAWINGS

Subject matter is particularly pointed out and distinctly claimed. Claimed subject matter, however, both as to organization and method of operation, together with objects, features, and advantages thereof, may best be understood by reference of the following detailed description when read with the accompanying drawings in which:

FIG. 1 is a diagram of a graphical user interface presenting a first panel and second panel in accordance with one or more embodiments;

FIG. 2 is an image of a document in accordance with one or more embodiments;

FIG. 3 is a diagram of a graphical user interface presenting a first panel and second panel including a displayed document and displayed hidden data respectively, in accordance with one or more embodiments;

FIGS. 4a-4d are diagrams of portions of a first panel and second panel including a displayed portion of a document and displayed hidden data respectively, in accordance with one or more embodiments;

FIG. 5 is a flow diagram of a method of displaying a document in accordance with one or more embodiments; and

FIG. 6 is a block diagram of a computing device in accordance with one or more embodiments.

It will be appreciated that for simplicity and/or clarity of illustration, elements illustrated in the figures have not necessarily been drawn to scale. For example, the dimensions of some of the elements may be exaggerated relative to other elements for clarity. Further, if considered appropriate, reference numerals have been repeated among the figures to indicate corresponding or analogous elements.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures and/or components have not been described in detail so as not to obscure claimed subject matter.

Reference throughout this specification to “one embodiment” or “an embodiment” means that a particular feature, structure, or characteristic described in connection with the embodiment is included in at least one embodiment of claimed subject matter. Thus, the appearances of the phrase “in one embodiment” and/or “an embodiment” in various places throughout this specification are not necessarily all referring to the same embodiment. Furthermore, the particular features, structures, and/or characteristics may be combined in one or more embodiments.

Unless specifically stated otherwise, as apparent from the following discussion, it is appreciated that throughout this specification discussions utilizing terms such as “processing”, “selecting”, “sending”, “receiving”, “determining”, “obtaining”, “interacting”, “storing”, “displaying”, “presenting”, “altering”, “manipulating” and/or the like refer to the actions and/or processes that may be performed via a computing device, which manipulates and/or transforms data represented as physical, electronic and/or magnetic quantities and/or other physical quantities within the computing device's processors, memories, registers, and/or other information storage, transmission, reception and/or display devices. Accordingly, a computing device refers to a system or a device that includes the ability to process and/or store data in the form of signals. Thus, embodiments of a computing device may comprise hardware, software, firmware and/or any combination thereof. Further, unless specifically stated otherwise, a process as described herein, with reference to flow diagrams or otherwise, may also be executed and/or controlled, in whole or in part, by a computing device.

A document may comprise a collection of information such as graphic objects, shapes, images, pictures, text, text boxes, software code, formatting data, forms, sub-forms, form fields, checkboxes, radio buttons and the like. The collection of data may be referred to as document parts. Furthermore, a document may comprise an on-screen or a printed document. An on-screen document may comprise document parts displayed as images displayed on a display. The display may be communicatively coupled to a computing device, for example. A printed document may comprise document parts printed on a medium. Additionally, an on-screen document may be employed to form a printed document, by printing a representation of the on-screen document on a print medium. Documents including on-screen documents and printed documents may be referred to as viewable documents. However, documents may comprise non-viewable documents. For example, non-viewable documents may comprise collections of data, wherein at least some of the data may not be viewable on-screen or as a printed document. Data that is non-viewable may include executable files, code, and the like, as just a few examples. A document may be formed in an authoring environment, and, when formed, may be suitable for use in a variety of applications, such as an on-screen document or a printed document, but claimed subject matter is not so limited. As a few examples, documents formed in accordance with one or more of the embodiments disclosed herein may include printed text-based documents, printed forms, on-screen forms, HTML or XML based pages suitable for executing and/or displaying via web browser software and the like, although, again, claimed subject matter is not limited in this respect.

A graphical user interface (GUI) generally refers to an interface for a software program executed by a computing device that is capable of utilizing graphics in conjunction with an input device to provide commands to the software program. In one or more embodiments, a graphical user interface may employ displayed graphical information to allow a user to control and/or operate a computing device and/or the like by use of an input device such as a pointing device. A pointing device may control a location of and movement of a cursor and/or other symbol that appears on a display screen to select objects, and/or input commands via a graphical user interface of a computing device and/or the like. A pointing device may refer to a device used to select objects, and/or input commands via a graphical user interface of a computing device and/or the like. Pointing devices may include, for example, a mouse, a trackball, a track pad, a track stick, a keyboard, a stylus, a digitizing tablet, and/or similar types of devices.

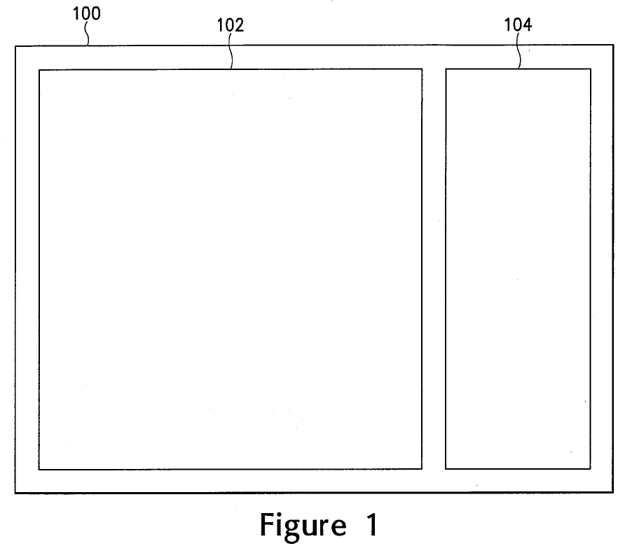

A computing device may cause a graphical user interface to be displayed on a display. The graphical user interface may be displayed as a layout, for example, and may be referred to as a GUI layout. A GUI layout may include various icons, images, data and/or other information displayed in an area on a display. A GUI layout may include one or more areas. The one or more areas may include one or more panels. A panel may refer to a sub-area of a GUI layout in which contents may be displayed. For example, a panel may refer to an area or a portion of a GUI layout within a graphical user interface that may contain contents. The contents may comprise parts of an on-screen document, icons, images, information, or other content or controls, for example. Referring to FIG. 1, a diagram of a GUI layout 100 including a first panel 102 and a second panel 104 in accordance with one or more embodiments will be described. As shown in FIG. 1, a GUI may be displayed as a layout on a display of a computing device. GUI layout 100 may include various icons, data and/or other information (not shown). GUI layout 100 includes a first panel 102 and a second panel 104. Although presented to have a particular arrangement within GUI layout 100, first panel 102 and second panel 104 are not limited in this respect. For example, in accordance with at least one embodiment, GUI layout 100 may include a plurality of panels that may be spatially arranged with respect to one another. For example, panels in accordance with one or more embodiments may be arranged horizontally, vertically, diagonally, overlayed and/or proximate with respect to one another, but the claimed subject matter is not so limited. Furthermore, as will be explained in greater detail later, in one embodiment, first panel 102 may include an on-screen document, and second panel 104 may include other information. The on-screen document displayed in first panel 102 may be spatially arranged with information displayed in second panel 104, for example. However, these are merely examples, and the scope of claimed subject matter is not limited in this respect. In one or more embodiments, a software program that may employ a graphical user interface may comprise a program such as Adobe® InDesign® type software, Adobe® Designer® type software, or Adobe® FlexBuilder® type software, or the like, available from Adobe Systems Incorporated of San Jose, Calif., USA. However, these are merely example types of software programs, and the scope of claimed subject matter is not limited in these respects.

A GUI may be employed when authoring a document, such as an on-screen or printed document, for example. A document being authored may comprise an on-screen document or a printed document, for example. In one particular embodiment, such documents may include information that may not be displayed as part of an on-screen and/or a printed document, but, nonetheless may affect the appearance and/or content of the document. Such information may be referred to as hidden data, and will be described in more detail later. When being authored in an authoring environment, a document being authored may be displayed as an on-screen document by employing a GUI and a display. In the authoring environment, hidden data may be displayed as part of the on-screen document. The hidden data may be displayed for a variety of reasons, such as to provide an author with a presentation of all hidden data included in the document, and/or to enable an author to access, manipulate and/or modify the hidden data. However, displaying the hidden data as part of the on-screen document may not be desirable for a number of reasons. For example, it may not be practical and/or possible to display all hidden as part of the on-screen document, or, when displayed as part of the on-screen document, displayed hidden data may affect the appearance of the on-screen document. Accordingly, displaying hidden data as part of an on-screen document may make determining the appearance of a final version of the on-screen document difficult. Additionally, in order for an author to visualize the appearance of a final version of an on-screen document or to understand hierarchical relationships or behavior between portions of an on-screen document, a preview of the document may be formed, which may be time consuming. Accordingly, in one embodiment of claimed subject matter, hidden data may be displayed via a GUI and a display, such that the hidden data may not interfere with the appearance of an on-screen document. In at least one embodiment, this may enable an author to access, manipulate and/or modify hidden data while also being able to visualize a final version of the on-screen document or to understand hierarchical relationships or behavior between portions of the on-screen document, for example However, this is just one embodiment, and claimed subject matter is not so limited.

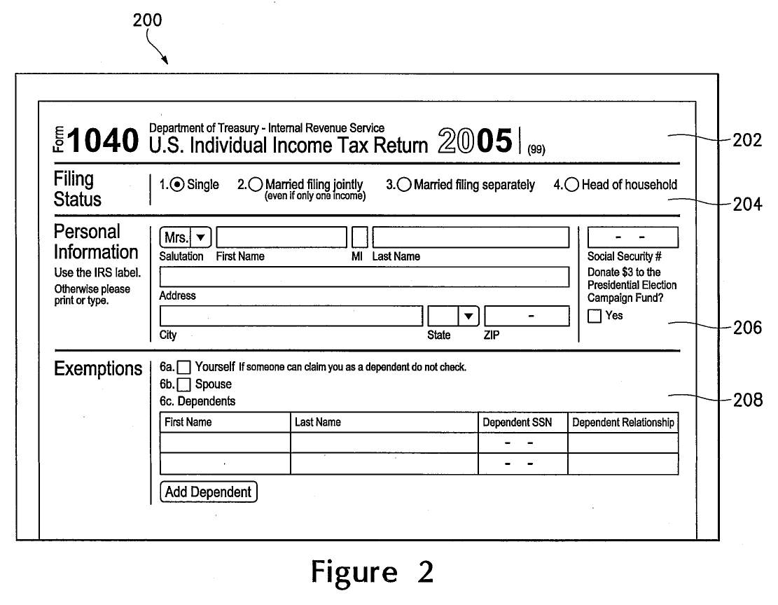

Referring now to FIG. 2, there is illustrated a document 200. Document 200 may comprise an on-screen document displayed on a display, and additionally, as mentioned previously, an on-screen document may be employed to form a printed document. In this embodiment, document 200 comprises a form and a plurality of sub-forms, although, as mentioned previously, a document may comprise a compilation of numerous other types and/or categories of data, and claimed subject matter is not so limited. In this context, a form and, additionally, a sub-form comprise portions of a document adapted to receive information, and may include form fields, radio buttons, check boxes, tool bars, slider bars, drop-down menus and the like, as just a few examples. However, it should be noted that sub-forms such as these may be included in an on-screen document, but may not necessarily be included in an associated printed document based on the on-screen document, or, when included in a printed document, may not necessarily be adapted to receive information. For example, an on-screen document may include form fields and drop-down menus adapted to receive information, but if the on-screen document was employed to form a printed document, the printed document form fields and/or drop-down menus may not be adapted to receive information.

Additionally, in at least one embodiment, a sub-form may further include a plurality of additional sub-forms, such as a plurality of form fields that may be included in one sub-form. Sub-forms that may be included as part of a document may share a hierarchical relationship and/or a contingent relationship with other sub-forms included in the document. For example, one or more sub-forms may have a hierarchical relationship such that one sub-form may affect information displayed in another sub-form and/or may affect the appearance of another sub-form. Additionally, one or more sub-forms may have a contingent relationship such that one sub-form may depend on another sub-form such that an appearance of one sub-form may depend at least in part on the presence, absence and/or appearance of another sub-form. As one example of a hierarchical relationship, a sub-form may comprise a drop-down menu. Information included in the drop down menu may be selectable when displayed as part of an on-screen document. Depending on the information that is selected, selection may cause an additional drop-down menu to be displayed as part of the on-screen document. These drop-down menus may share a hierarchical relationship, such that selection of information in one drop-down menu may cause the other drop-down menu to be displayed. However, this is just one example of a hierarchical relationship, and the claimed subject matter is not so limited. Additionally, hierarchical relationships will be explained in greater detail below. Continuing with FIG. 2, document 200 includes a plurality of document parts. For example, document 200 includes a title sub-form 202 and sub-form 204, having one or more radio buttons. Document 200 additionally includes sub-form 206, which, here, includes a plurality of form fields and a checkbox, which may individually be referred to as sub-forms. Document 200 additionally includes sub-form 208, which, in this example, includes a plurality of sub-forms having form fields and check boxes. The document parts of document 200, may, in combination, comprise a form.

Additional, although not illustrated in FIG. 2, document 200 may include hidden data. In this context, hidden data may comprise data that may not be displayed as part of document 200, but may be displayed in an authoring environment when document 200 is being authored. Hidden data, in at least one embodiment, may affect an appearance and/or content of an on-screen and/or an associated printed document. In at least one embodiment of claimed subject matter, hidden data may be selectively displayed and/or not displayed as part of an on-screen document, and/or may be employed to result in altering the appearance of a document. Additionally, when displayed in the authoring environment, the hidden data may be employed to alter and/or manipulate one or more parts of document 200. For example, a sub-form may be hidden and not displayed as part of document 200, but may be displayed on a panel presented in a GUI layout. The hidden sub-form may be altered and/or manipulated, and the document may be altered and/or manipulated in response to the altering and/or manipulating of the hidden sub-form, such that the sub-form is selectively displayed as part of document 200. However, this is just an example, and additional embodiments will be explained in more detail herein.

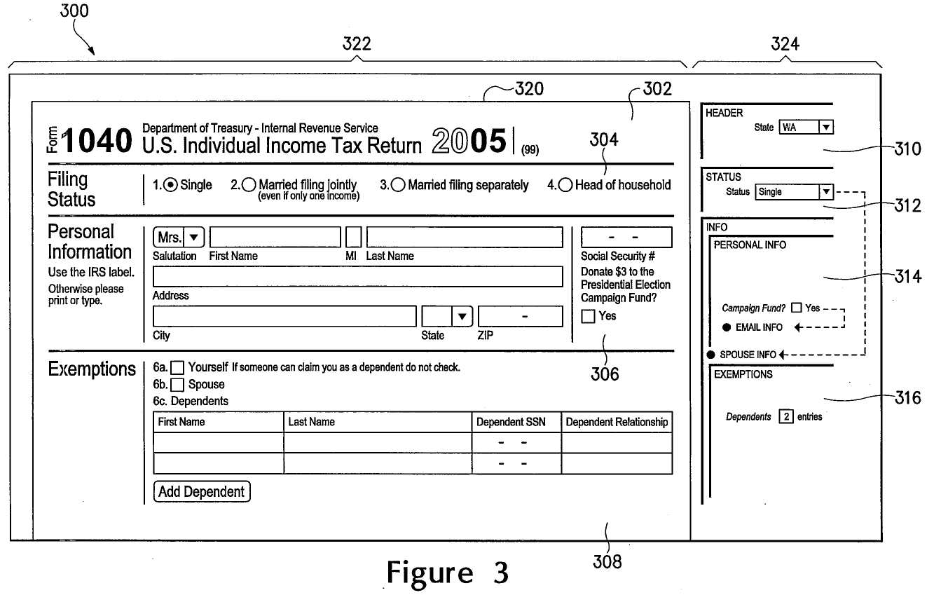

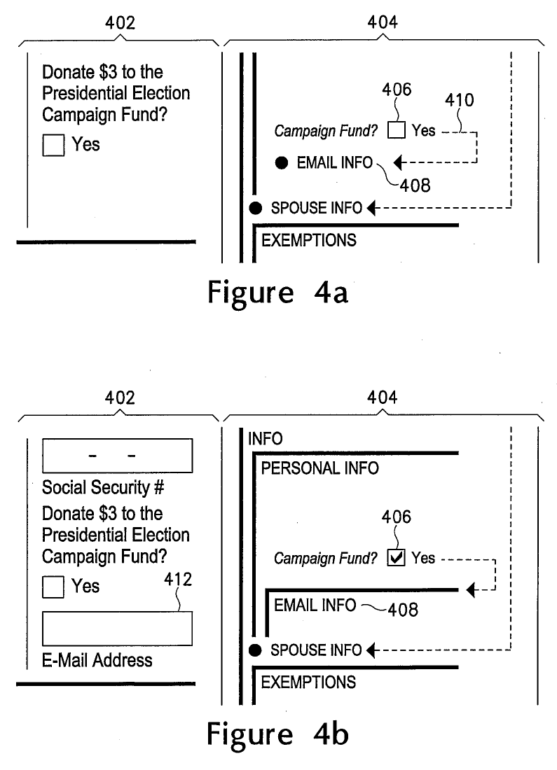

A document such as document 200 of FIG. 2 may be created and/or edited in an authoring-environment. An authoring environment may employ a display and a GUI to enable displaying one or more parts of an on-screen document while the document is being created and/or edited. A GUI may present a GUI layout and at least a first panel in the GUI layout. Here, one or more parts of an on-screen document may be displayed in the first panel. In at leastzone embodiment, the displayed one or more parts in the first panel may be displayed as all or part of a “what you see is what you get” (WYSIWYG) document, meaning, in this context, that the displayed one or more parts of the on-screen document has the same or substantially the same appearance as a final or published version of the document may have when printed as a printed document or as displayed as an on-screen document. Displaying a WYSIWYG document in the first panel may enable an author to visualize an appearance of a final version of a document. This may be desirable by not requiring an author to form a preview of an on-screen document in order to for the author to visualize an appearance of a final version of the on-screen document or to understand hierarchical relationships or behavior between portions of a document, for example. Additionally, at least a second panel may be presented in the GUI layout. The second panel may display information that may not be visible in as part of the document, such as hidden data. In at least one embodiment, such hidden data may be displayed and arranged in the second panel such that a spatial relationship may exist between parts of the displayed document and the hidden data. However, specific examples of spatial relationships will be explained in more detail with reference to FIGS. 3-4d.

Referring now to FIG. 3, there is illustrated a GUI layout 300 that may be employed in an authoring environment. GUI layout 300 may be displayed on a display communicatively coupled to a computing device, although claimed subject matter is not so limited. In such an authoring environment, GUI layout 300 includes a first panel 322 and a second panel 324. The first and/or second panel may be automatically and/or selectively displayed in the authoring environment, and may be selectively displayed or not displayed in response to user input, for example. First panel 322 includes on-screen document 320. In this embodiment, document 320 is displayed in first panel 322, and hidden data 310-316 is displayed in a second panel 324 of GUI layout 300. In this embodiment, second panel 324 is arranged in GUI layout 300 horizontally proximate to first panel 322, although it is worthwhile to note that claimed subject matter is not so limited. For example, embodiments of claimed subject matter may employ a plurality of panels displayed in a GUI layout in various orientations and/or configurations with respect to one another, such as side by side, corner to corner, overlayed and/or top and bottom, as just a few examples. In this embodiment, document 320 comprises a form, although claimed subject matter is not so limited. In this embodiment, document 320 includes a plurality of document parts. For example, document 320 includes a title sub-form 302, and a sub-form 304, which includes a plurality of radio buttons. Document 300 additionally includes form field sub-forms 306 and 308, which include a plurality of form fields and/or checkboxes.

Continuing with this embodiment of FIG. 3, second panel 324 is displayed in GUI layout 300. Second panel 324 includes displayed hidden data 310-316. The displayed hidden data 310-316 may be displayed on the second panel 310-316 such that a spatial relationship exists between one or more portions of hidden data 310-316 and one or more parts of document 300. For example, second panel 324 includes title sub-form hidden data 310, which, in this embodiment, is arranged horizontally proximate to one side of title sub-form 302 of document 300. Second panel 324 additionally includes sub-form hidden data 312, arranged horizontally proximate to one side of sub-form 304, and form field sub-form hidden data 314-316, which are arranged horizontally proximate to one side of form field sub-forms 306 and 308, respectively. However, as mentioned previously, claimed subject matter is no so limited. Furthermore, other configurations and/or arrangements of panels within a GUI layout are in accordance with one or more embodiments. For example, any arrangement of at least a first and a second panel, wherein one of the panels includes a document and one of the other panels includes displayed hidden data is in accordance with one or more embodiments.

Panels 322 and 324 are arranged such that hidden data has a spatial relationship with one or more parts of document 320, meaning, in this context, that the arrangement of hidden data 310-316 of panel 324 and the one or more parts 302-308 of document 320 of panel 322 are discernable based at least in part on the manner in which the hidden data and the one or more associated parts are arranged with respect to one another. For example, in alternative embodiments, panel 322 may be arranged above or below panel 324, and likewise, panel 324 may be arranged to one or more sides of panel 322, and/or above, below, side to side, corner to corner, at least partially on top of or overlayed with respect to panel 322, for example. Additionally, individual parts of panels 322 and/or 324 maybe arranged with respect to one another such that a spatial relationship exists between parts of panels 322 and 324. For example, panels 322 and/or 324 may be broken out into sub-panels (not shown), and may include parts of document 320, for example. Sub-panels may be arranged proximate to one another such as in a manner described previously. Additionally, a part of panel 324 may be overlayed over a part of panel 322, in at least one embodiment. However, these are merely examples, and, as stated previously, claimed subject matter is not so limited.

Continuing with this embodiment of FIG. 3, document 320 displayed in first panel 322 of GUI layout 300 may comprise a WYSIWYG document. Additionally, in this embodiment, hidden data 310-316 displayed in second panel 324 may be capable of being manipulated and/or altered. Manipulating and/or altering one or more of hidden data 310-316 may result in the appearance of document 320 being altered. For example, referring to FIG. 4a, there is illustrated a portion of document 320 of FIG. 3 and a portion of hidden data 310-316 of FIG. 3. In this example, a sub-form 402 is displayed in a first panel of a GUI layout (not shown). Sub-form 402 comprises a portion of form field sub-form 306 of FIG. 3. Hidden data 404 is displayed in a second panel of the GUI layout (not shown). The displayed hidden data is arranged such that a spatial relationship exists between sub-form 402 and hidden data 404. For example, in this embodiment, hidden data 404 is arranged horizontally proximate to one side of sub-form 402, although, as mentioned previously, claimed subject matter is not so limited. In this embodiment, displayed hidden data 404 includes a sub-form representation 406, which comprises a representation of a portion of sub-form 402. Displayed hidden data 404 also includes hidden sub-form 408. Hidden sub-form 408 comprises data associated with sub-form 402, but may not be displayed as part of document 320, for example. Displayed hidden data 404 also includes dotted line 410, which, in this embodiment, indicates that a relationship, such as a hierarchical relationship exists between sub-form representation 406 and hidden sub-form 408. This relationship will be explained in more detail hereinafter.

At least a portion of hidden data 404 is capable of being manipulated and/or altered. Manipulating and/or altering at least a portion of hidden data 404 may result in altering the appearance of at least a portion of sub-form 402. For example, sub-form representation 406 includes a checkbox having a similar configuration as the checkbox included in sub-form 402. The checkbox of sub-form representation 406 may be selectively checked or unchecked, and checking and/or unchecking the checkbox of sub-form representation 406 may result in the altering of the appearance of sub-form 402. For example, referring now to FIG. 4b, checkbox of sub-form representation 406 is checked. Accordingly, in response to checking, sub-form 412, which comprises an email address field, may be displayed as part of sub-form 402. Additionally, in this embodiment, in response to checking checkbox of sub-form representation 406, hidden sub-form 408 may be expanded, although this is just one example, and claimed subject matter is not so limited. In this embodiment, expanding hidden sub-form 408 may be performed to reveal additional information such as an additional sub-form (not shown) which may be included as part of hidden sub-form 408. As illustrated with reference to FIGS. 4a and 4b, altering and/or manipulating hidden data 404 results in altering the appearance of document 320 of FIG. 3, namely sub-form 402.

Furthermore, illustrated in FIGS. 4c-4d is another example embodiment of altering the appearance of a document by altering an/or manipulating hidden data. Illustrated in FIG. 4c is a portion of document 320 of FIG. 3. In this example, sub-form 420 is displayed in a first panel of a GUI layout (not shown). Sub-form 420 comprises a portion of form field sub-form 308 of FIG. 3, and includes two rows of form fields 422. Additionally, referring to FIG. 4d, Hidden data 424 is displayed in a second panel of the GUI layout (not shown). The displayed hidden data is arranged such that a spatial relationship exists between sub-form 420 and hidden data 424. For example, in this embodiment, hidden data 424 is arranged horizontally proximate to one side of sub-form 420. In this embodiment, displayed hidden data 424 includes a hidden sub-form 426. Hidden sub-form 426 may have a form field that allows entering a number of rows of-form fields 422 to display in the sub-form 420. Entering a number in sub-form 426 may result in altering the appearance of sub-form 420. For example, changing the number in hidden sub-form 426 from 2 to 5 will result in sub-form 420 displaying 5 rows of form fields instead of 2 rows of form fields. As illustrated with reference to FIGS. 4c and 4d, altering and/or manipulating hidden data 424 results in altering the appearance of a portion of a document, namely sub-form 420. However, it is worthwhile to note that the claimed subject matter is not so limited, and other types and/or categories of altering and/or manipulating hidden data are in accordance with at least one embodiment. For example, hidden data may be altered: such that portions of the hidden data are selectively hidden and/or displayed, in a first and/or second panel of a GUI (not shown), such that contents of the hidden data are manipulated and/or altered, such that other characteristics or variables associated with the hidden data are altered, and/or to change a name of a portion of hidden data, such as the name of a sub-form, as just a few examples. Altering and/or manipulating hidden data in this manner may or may not result in altering the appearance of a document, and may depend, at least in part, on the type of alteration and/or manipulation, for example.

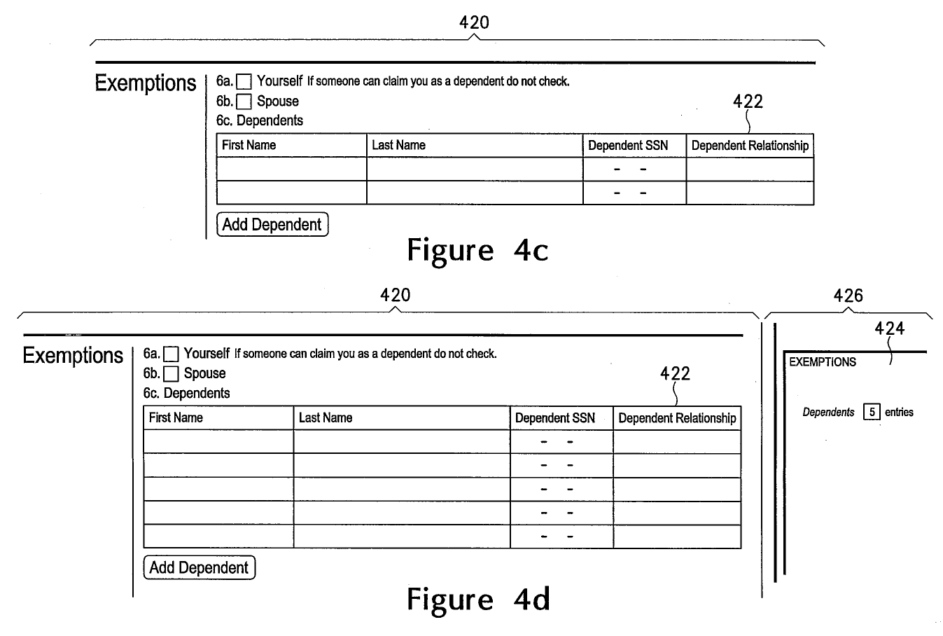

FIG. 5 is a flow diagram of a process 500 according to an embodiment of displaying a document. In this example embodiment, at block 502, a first panel is presented. The first panel may be presented in a portion of a graphical user interface window, for example. The presented first panel may include a document, such as one or more parts of a document. The displayed document may be employed as an on-screen document or printed document, as explained above. In at least one embodiment, the first panel may be presented on a display communicatively coupled to a computing device. At block 504, a second panel is presented. The second panel may be presented in a portion of a graphical user interface window, for example, and may be presented in a particular arrangement in the window relative to the first panel, such that at least a portion of the contents of the first panel has a spatial relationship with at least a portion of the contents of the second panel. For example, the second panel may be presented adjacent to one or more sides, the top, the bottom and/or one or more corners of first panel, and/or may be overlayed on at least a portion of the first panel. Additionally, the second and/or the first panel may be layered and/or tabbed and may be presented behind the first and/or second panel, respectively. The presented second panel may include displayed hidden data associated with one or more parts of the document at least partially displayed in the first panel. At block 506, contents of the second panel may be manipulated and/or altered. For example, displayed hidden data may be manipulated and/or altered by manipulating a sub-form and/or adding or deleting the displayed hidden data, for example. At block 508, a presented portion of a document, such as one or more parts of a document may be manipulated in response to the manipulation and/or alteration of the displayed hidden data. For example, a hidden sub-form may be manipulated at block 506. At block 508, in response to manipulating the hidden sub-form, the appearance of the displayed portion of the document in the first panel may be altered. However, this is just one example, and claimed subject matter is, not so limited.

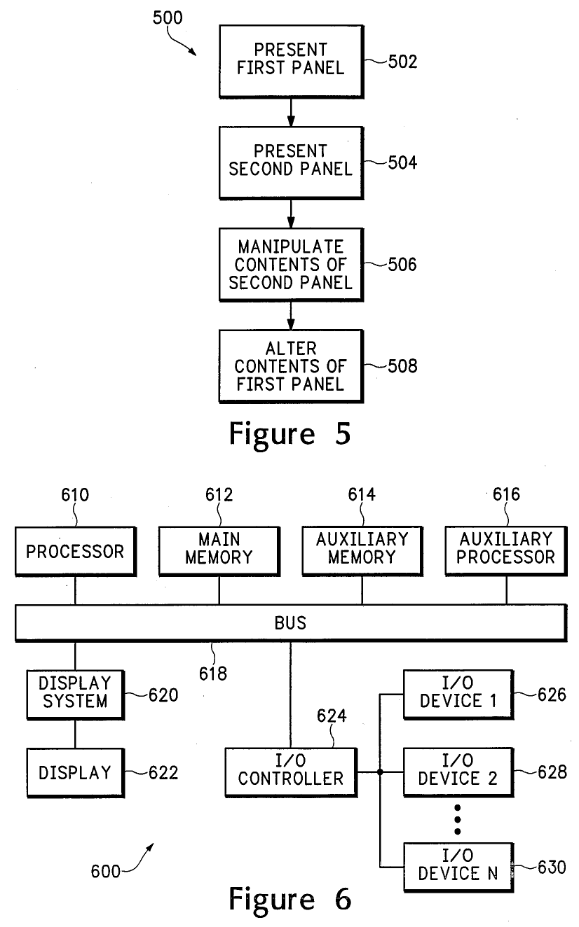

Referring now to FIG. 6, a block diagram of a computing device in accordance with one or more embodiments is illustrated. Computing device 600 as shown in FIG. 6 may tangibly embody executable instructions that may result in an execution of one or more of the above-described embodiments. Computing device 600 may additionally be executed to implement GUI 100 of FIG. 1 in which window 110 may be displayed. Such a computer program and/or machine readable instructions may be tangibly stored on a computer and/or machine readable medium such as a compact disk (CD), digital versatile disk (DVD), flash memory device, hard disk drive (HDD), and so on. Computing device 600 may be controlled by processor 610. Processor 610 may comprise a central processing unit such as a microprocessor or microcontroller for executing programs, performing data manipulations and controlling the tasks of computing device 600. Communication with processor 600 may be implemented via bus 618 for transferring information among the components of computing device 600. Bus 618 may include a data channel for facilitating information transfer between storage and other peripheral components of computing device 618. Bus 618 further may provide a set of signals utilized for communication with processor 610, including, for example, a data bus, and address bus, and/or a control bus.

Other components of computing device may include, for example, main memory 612, and/or auxiliary memory 614. Computing device 600 may further comprise auxiliary processing processor 616, which may be another processor, a digital signal processor, and so on. Main memory 612 may provide storage of instructions and data for programs to be executed by processor 610. Main memory 612 may be, for example, semiconductor-based memory such as dynamic random access memory (DRAM) and/or static random access memory (SRAM), and/or the like. Auxiliary memory 612 may be utilized to store instructions and/or data that to be loaded into main memory 612 before execution. Auxiliary memory 614 may include semiconductor based memory such as read-only memory (ROM), programmable read-only memory (PROM), erasable programmable read-only memory (EPROM), electrically erasable read-only memory (EEPROM), and/or flash memory, and/or any block oriented memory similar to EEPROM. Auxiliary memory 614 may also include any type of non-semiconductor-based memories, including but not limited to magnetic tape, drum, floppy disk, hard disk, optical, laser disk, compact disc and/or the like. Computing device 600 optionally include auxiliary processor 616 which may be an auxiliary processor to manage input/output, an auxiliary processor to perform floating point mathematical operations, a digital signal processor and/or any special-purpose microprocessor having an architecture suitable for fast execution of signal processing algorithms, a back-end processor and/or any slave type processor subordinate to processor 610, an additional microprocessor and/or controller for dual and/or multiple processor systems, and/or a coprocessor and/or additional processor. Such auxiliary processors may be discrete processors and/or or may be arranged in the same package as processor 610, for example in a multicore and/or multithreaded processor, however the scope of claimed subject matter is not limited in these respects.

Computing device 600 further may include display system 620 for connecting to display 622, and further may include input/output (I/O) controller 624 to connect to one or more I/O devices including, for example, I/O device 626, I/O device 628, up to an Nth I/O device, I/O device 630. Display system 620 may comprise a video display adapter having components for driving display 622, including, for example, video memory, a buffer, and/or a graphics engine. Display 622 may comprise a cathode ray-tube (CRT) type display such as a monitor and/or television, and/or may comprise an alternative type of display technology such as a projection type CRT type display, a liquid-crystal display (LCD) projector type display, an LCD type display, a light-emitting diode (LED) type display, a gas and/or plasma type display, an electroluminescent type display, a vacuum fluorescent type display, a cathodoluminescent and/or field emission type display, a plasma addressed liquid crystal (PALC) type display, a high gain emissive display (HGED) type display, and so forth. Input/output controller 624 may comprise one or more controllers and/or adapters to prove interface functions between one or more of I/O device 626, I/O device 628, and/or I/O device 630. For example, input/output controller 624 may comprise a port to interface between corresponding I/O devices such as a keyboard, mouse, trackball, touchpad, joystick, trackstick, and/or the like. Input/output controller 624 and/or I/O device 626, I/O device 628, and/or I/O device 630 may provide and/or receive analog and/or digital signals to communicate between computing device and external devices, networks, and/or information sources. Computing device 400 of FIG. 6 is merely one example of an computing device and/or computing platform, and the scope of claimed subject matter is not limited in this respect.

In the preceding description, various aspects of claimed subject matter have been described. For purposes of explanation, systems and configurations were set forth to provide a thorough understanding of claimed subject matter. However, it should be apparent to one skilled in the art having the benefit of this disclosure that claimed subject matter may be practiced without the specific details. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that appended claims are intended to cover all such modifications and/or changes as fall within the true spirit of claimed subject matter.

1. A method, comprising:
presenting a first panel in a first portion of a display, the first panel displaying one or more content portions of a document, wherein one of the one or more displayed content portions of the document has a hierarchical relationship with another document content portion, wherein at least part of the other document content portion is not displayed, wherein the hierarchical relationship enables a manipulation of the one content portion in the document to cause the at least part of the other document content portion to be displayed; and
presenting a second panel in a second portion of a display, the second panel displaying hidden data associated with the one or more content portions of the document and the other document content portion regardless of whether the other document content portion is displayed, wherein the displayed hidden data comprises hidden data pertaining to the hierarchical relationship between the one content portion and the other document content portion, wherein a manipulation of the hidden data pertaining to the hierarchical relationship causes the at least part of the other document content portion to be displayed in the first panel;
wherein at least some of the displayed hidden data is arranged in the second panel to have a spatial relationship with an associated portion of the one or more content portions of the document in the first panel.

2. The method of claim 1, further comprising altering an appearance of one or more content portions of the document in the first panel in response to manipulation of hidden data in the second panel associated with the one or more content portions.

3. The method of claim 2, wherein the one or more content portions of a document displayed in the first panel comprise at least a portion of a WYSIWYG document.

4. The method of claim 2, wherein manipulating the hidden data comprises:
selectively showing and/or hiding hidden data in the first panel, altering the contents of the hidden data, and/or renaming one or more portions of the first and/or second panel.

5. The method of claim 1, wherein the document comprises a form.

6. The method of claim 5, wherein the one or more content portions comprise one or more form fields.

7. The method of claim 5, wherein the hidden data comprises one or more subforms.

8. The method of claim 4, wherein the second panel is presented in display adjacent to one side of the first panel.

9. The method of claim 1, wherein the hidden data comprises formatting data for the document.

10. An apparatus, comprising:
a processor; and
memory storing program instructions executable by the processor to implement:
a graphical user interface (GUI) having a GUI layout;
a first panel presented in the GUI layout, the first panel displaying one or more content portions of a document, wherein one of the one or more displayed content portions of the document has a hierarchical relationship with another document content portion, wherein at least part of the other document content portion is not displayed, wherein the hierarchical relationship enables a manipulation of the one content portion in the document to cause the at least part of the other document content portion to be displayed; and
a second panel presented in the GUI layout, the second panel displaying hidden data associated with the one or more content portions of the document and the other document content portion regardless of whether the other document content portion is displayed, wherein the displayed hidden data comprises hidden data pertaining to the hierarchical relationship between the one content portion and the other document content portion, wherein a manipulation of the hidden data pertaining to the hierarchical relationship causes the at least part of the other document content portion to be displayed in the first panel;
wherein at least some of the displayed hidden data is arranged in the second panel to have a spatial relationship with an associated portion of the one or more content portions of the document in the first panel.

11. The apparatus of claim 10, wherein the GUI is adapted to:
receive instructions to manipulate hidden data in the second panel; and
alter an appearance of one or more content portions of the document in the first panel in response to manipulation of the hidden data.

12. The apparatus of claim 10, wherein the one or more content portions of a document displayed in the first panel comprises a WYSIWYG document.

13. The apparatus of claim 11, wherein receiving instructions to manipulate hidden data further comprises:
receiving instructions to selectively show and/or hide hidden data in the first panel, alter the contents of the hidden data, and/or rename one or more portions of the first and/or second panel.

14. The apparatus of claim 10, wherein the document comprises a form.

15. The apparatus of claim 14, wherein the one or more content portions comprise one or more form fields.

16. The apparatus of claim 14, wherein the hidden data comprises one or more subforms.

17. The apparatus of claim 14, wherein the second panel is presented in display adjacent to one side of the first panel.

18. The apparatus of claim 10, wherein the hidden data comprises formatting data for the document.

19. A system, comprising:
a display;
a computing device communicatively coupled to the display, wherein the computing device is adapted to execute a graphical user interface (GUI) to result in displaying a GUI layout on the display, the GUI layout further comprising:
a first panel, the first panel displaying one or more content portions of a document, wherein one of the one or more displayed content portions of the document has a hierarchical relationship with another document content portion, wherein at least part of the other document content portion is not displayed, wherein the hierarchical relationship enables a manipulation of the one content portion in the document to cause the at least part of the other document content portion to be displayed; and
a second panel in a second portion of a display, the second panel displaying hidden data associated with the one or more content portions of the document and the other document content portion regardless of whether the other document content portion is displayed, wherein the displayed hidden data comprises hidden data pertaining to the hierarchical relationship between the one content portion and the other document content portion, wherein a manipulation of the hidden data pertaining to the hierarchical relationship causes the at least part of the other document content portion to be displayed in the first panel;
wherein at least some of the displayed hidden data is arranged in the second panel to have a spatial relationship with an associated portion of the one or more content portions of the document in the first panel.

20. The system of claim 19, wherein the computing device is further adapted to execute the GUI to result in:
receiving instructions to manipulate hidden data in the second panel; and
altering an appearance of one or more content portions of the document in the first panel in response to manipulation of the hidden data.

21. The system of claim 19, wherein the one or more content portions of a document displayed in the first panel comprises a WYSIWYG document.

22. The system of claim 20, wherein receiving instructions to manipulate hidden data further comprises:
receiving instructions to selectively show and/or hide hidden data in the first panel, alter the contents of the hidden data, and/or rename one or more portions of the first and/or second panel.

23. The system of claim 22, wherein the second panel is presented in display adjacent to one side of the first panel.

24. The system of claim 19, wherein the hidden data comprises formatting data for the document.

25. An article comprising a non-transitory storage medium having stored thereon instructions, that, when executed, result in:
presenting a first panel in a first portion of a display, the first panel displaying one or more content portions of a document, wherein one of the one or more displayed content portions of the document has a hierarchical relationship with another document content portion, wherein at least part of the other document content portion is not displayed, wherein the hierarchical relationship enables a manipulation of the one content portion in the document when published to cause the at least part of the other document content portion to be displayed; and
presenting a second panel in a second portion of a display, the second panel displaying hidden data associated with the one or more content portions of the document and the other document content portion regardless of whether the other document content portion is displayed, wherein the displayed hidden data comprises hidden data pertaining to the hierarchical relationship between the one content portion and the other document content portion, wherein a manipulation of the hidden data pertaining to the hierarchical relationship causes the at least part of the other document content portion to be displayed in the first panel;
wherein at least some of the displayed hidden data is arranged in the second panel to have a spatial relationship with an associated portion of the one or more content portions of the document in the first panel.

26. The article of claim 25, wherein the instructions, when executed, further result in:
altering an appearance of one or more content portions of the document in the first panel in response to manipulation of hidden data in the second panel associated with the one or more.

27. The article of claim 25, wherein the one or more content portions of a document displayed in the first panel comprises a WYSIWYG document.

28. The article of claim 25, wherein the second panel is displayed adjacent to the first panel in the window.

29. The article of claim 25, wherein the document comprises a form.

30. The article of claim 25, wherein the hidden data comprises one or more subforms.

31. The article of claim 25, wherein the hidden data comprises formatting data for the document.
